(19) United States
(12) Patent Application Publication
(10) Pub. No.: US 2008/0302004 A1
(43) Pub. Date: Dec. 11, 2008

(54) MULTIFUNCTION PLANT CULTIVATION LED ABLE TO CONTROL THE GROWING SPEED OF PLANTS

(76) Inventor: Yu-Ho LIN, (US)

Correspondence Address: SINORICA, LLC, 528 FALLSGROVE DRIVE, ROCKVILLE, MD, 20850, US

(21) Appl. No.: 11/759,797

(22) Filed: Jun. 7, 2007

(51) Int. Cl. A01G 9/20

(52) U.S. Cl. 47/58.1 LS

(57) ABSTRACT

A multifunction plant cultivation LED able to control the growing speed of plants is to properly select the composition material and proportion of LED to enable the LED to emit light with different wavelengths and colors. Then, specific wavelengths beneficial to the growth of plants and able to offer best bright for human naked eyes are selected from light spectrums to make up a LED light source with multiple wavelengths for irradiating landscaping plants and flowers and controlling their growing speed as well as for seeing, enjoying and for lighting, versatile in use, having high efficiency and saving electricity.

### BACKGROUND OF THE INVENTION

1. Field of Invention

This invention relates to an LED, particularly to one not only helpful to speed up growth of terrestrial flowers and plants as well as aquatic plants, but also able to be used for seeing and enjoying and for lighting.

2. Description of the Related Art

As commonly known, light is indispensable for cultivating plants and flowers. Generally, conventional lamps, such as electric bulbs and fluorescent lamps, are employed to offer sufficient and incessant light for helping speed up the growth of plants.

However, plants are different from human bodies in sensitivity toward light. Among output light spectrums, only the light quantity and the light wavelengths of specific wave bands are beneficial to the growth and the photosynthesis of plants, and light with different wavelengths will produce different effects on different kinds of plants. Substantially, wavelengths applicable to the growth of plants cannot effectively be selected and separated from the conventional plant cultivation lamps, and as a result, some wave bands in the output light spectrums, which are not beneficial to the growth of plants, will cause light loss. In addition, the conventional lamp is likely to waste electricity and shorten its service life, thus increasing cost in maintenance and replacement.

### SUMMARY OF THE INVENTION

The objective of this invention is to offer a multifunction plant cultivation LED able to control the growing speed of plants. LEDs with different wavelengths, colors and effects in the present invention are arranged in sequence and combined into a light source able to control the growing speed of plants according to a user's need in plant cultivating and landscaping.

The feature of the multifunction plant cultivation LED in the present invention is a multiple-band LED light source composed of different-wavelength LEDs for irradiating for speeding up the growth of plants. Since plants and human bodies are different in sensitivity toward light, the composition materials and proportion of LED of this invention are properly selected to enable the LED to emit light with different wavelengths and colors, and then specific wavelengths beneficial to the growth of plants and able to offer best light for human naked eyes are selected from the light spectrums through tests, such as including 430 nm, 555 nm and 630 nm. Subsequently, the LEDs with different wavelengths are arranged and combined into a multiple-band LED light source for irradiating landscaping plants and flowers and controlling their growing speed and for seeing and enjoying as well as for lighting. In addition, the output efficiency of effective light quantity of such LEDs can reach 100% and the power consumption of such LEDs is only ½- 1/10 of the same-class conventional lamps. The service life of such LEDs can last for 50,000 hours, and such LEDs do not contain any heavy metal like lead or mercury, having high efficiency, greatly saving electricity and contributing to environmental protection.

### BRIEF DESCRIPTION OF THE DRAWINGS

The above and other objects of the present invention will become readily apparent by reference to the following detailed description when considered in conjunction with the accompanying drawings wherein:

FIG. 1 is a perspective view of a first preferred embodiment of multifunction plant cultivation LED in the present invention.

FIG. 2 is a perspective view of a second preferred embodiment of the multifunction plant cultivation LED positioned at a location higher than the water level of an aquarium in the present invention.

FIG. 3 is a perspective view of the second preferred embodiment of the multifunction plant cultivation LED positioned at a proper location in the water of an aquarium in the present invention.

FIG. 4 is an aquatic plant distribution view of the second preferred embodiment in the present invention.

FIG. 5 is a disposition view of the LEDs of an LED light source of the second preferred embodiment in the present invention.

### DETAILED DESCRIPTION OF THE INVENTION

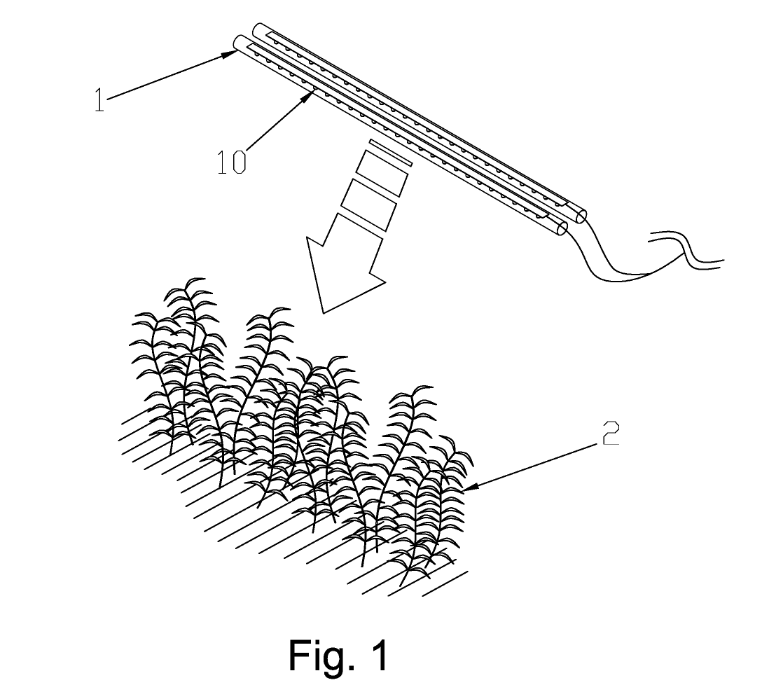

A first preferred embodiment of a multifunction plant cultivation LED able to control the growing speed of plants in the present invention, as shown in FIG. 1, is to properly select the composition materials and the proportion of components of LED 10 so as to enable the LED 10 to emit light with different wavelengths and colors. Afterward, specific wavelengths beneficial to the growth of plants and able to offer best light for human naked eyes are selected from the light spectrums through tests, and then these LEDs with different wavelengths are arranged and combined into a multiple-band LED light source 1 used for irradiating the plants 2.

It is known to the electronic sectors that LED composed of different-proportion and different-kind compound can emit light quantity with different wavelengths and reveal different colors.

The wavelength of blue and blue-green light is within the wave bands of 400 nm-490 nm, which are used by chlorophyll of plant cells to carry out photosynthesis. Since the shorter the wavelength is, the greater the light-transmission power will be; therefore, the light-transmission power of these wave bands can keep unchanged in water of 60 cm deep. Blue light with short wavelength will disable plants and flowers to grow upward but enable plants to grow horizontally and make their leaves grow thick; therefore lamplight with wavelength of such wave bands is suitable for irradiating light on the flowers and plants in a foreground.

The wavelength of orange-yellow and red light is within the wave bands of 600 nm-700 nm. Since the chlorophyll of plant cells has the strongest absorbing power for absorbing red light, the light of this wave band is most beneficial for plants and flowers to carry out photosynthesis, and light with more red wavelengths is beneficial for leaves to sprout and grow upward. Therefore, lamplight with the wavelength of such wave bands is suitable for lighting the flowers and plants in a background.

In addition, the wave bands of light spectrums, which human naked eyes can feel most sensitively are 550 nm-555 nm. The so-called “common lamps” refer to the lamps used for lighting in daily life. The wave bands of light of the common lamps are concentrated within 550 nm-555 nm, which can offer best and brightest light for human naked eyes.

Through the above-mentioned analysis, this invention selects three specific wavelengths 430 nm, 555 nm and 630 nm from foresaid wavelengths 400-490 nm, 550-555 nm and 600-700 nm. These three specific wavelengths 430 nm, 555 nm and 630 nm not only can effectively control the growing speed of plants and flowers, but also offer best light that human eyes can perceive. In accordance with the purpose and need of plant growing and the region for plant landscaping and by using waterproof lamps, the LEDs 10 with these three wavelengths are arranged from the front to the rear, or from the right to the left or arranged in different directions at an emphasized partial portion and combined into an LED light source 1. Thus, the growing speeds of the plants and flowers cultivated at the front and the rear side or at the left and the right side can be adjusted and controlled according to a user's needs, not only achieving effect of various landscapings, but offering lighting needed by the user and best light for seeing and enjoying. Additionally, the LEDs 10 able to reveal various colors can serve as decoration.

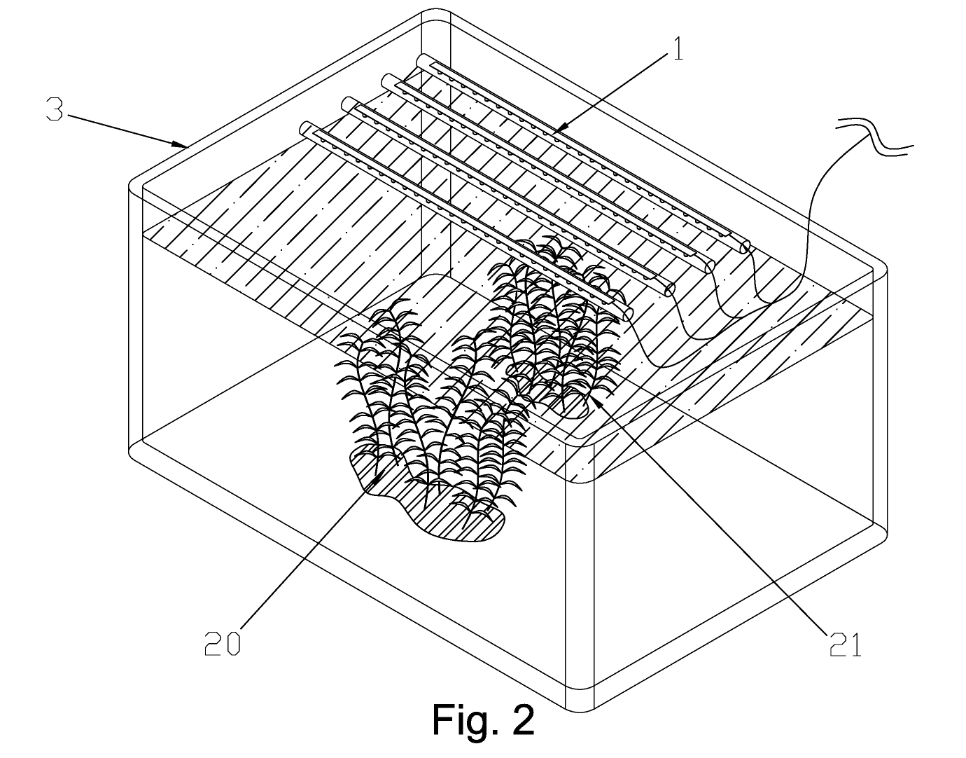

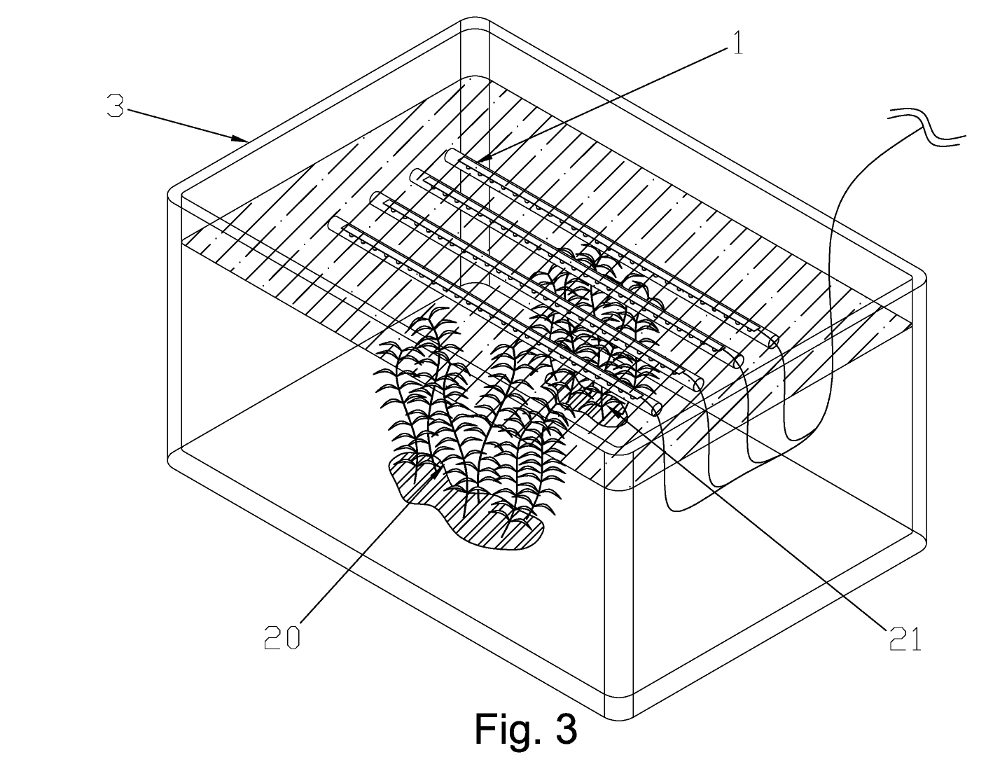

A second preferred embodiment of a multifunction plant cultivation LED able to control the growing speed of plants is to position the LED light source 1 at a location higher than the water level of an aquarium 3, as shown in FIG. 2, or at a proper location in the water of an aquarium, as shown in FIG. 3, for providing the aquarium 3 with sufficient light and for light embellishing.

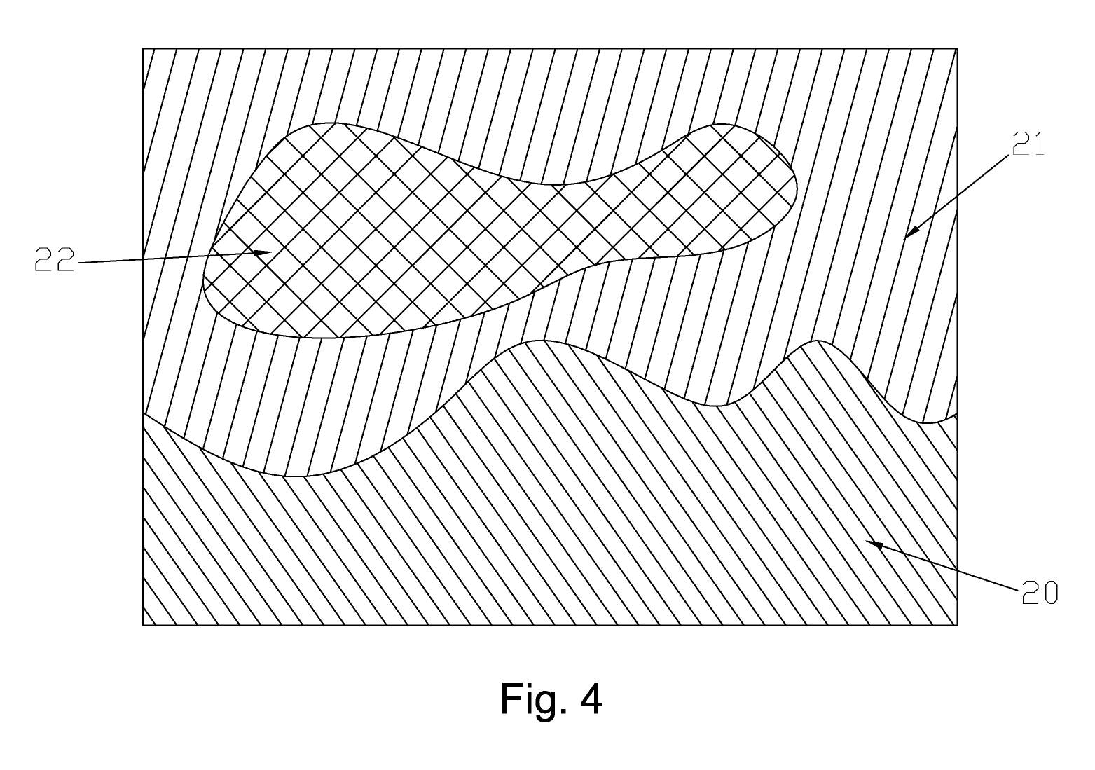

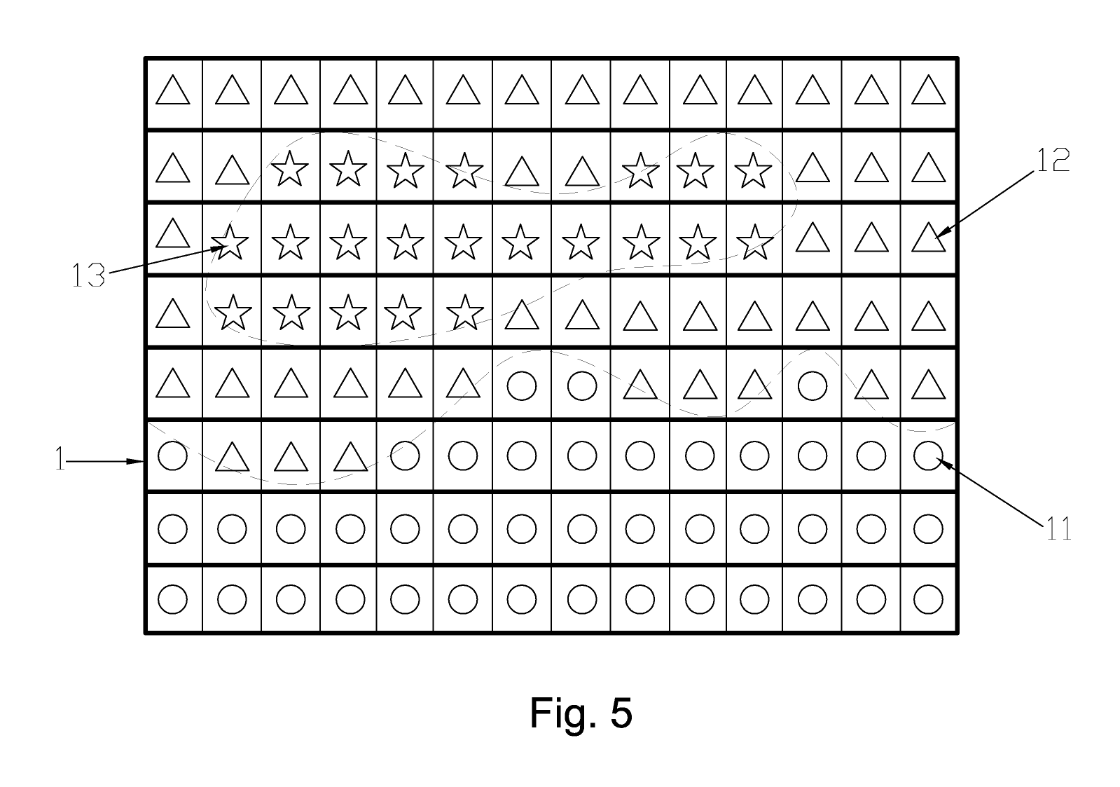

FIG. 4 is an aquatic plant distribution view, and FIG. 5 is a disposition view of the LEDs of the LED light source.

The LED light source 1 with multiple wavelengths in the present invention is to position the LEDs 11, which are able to emit blue-green light, at the front side to let the aquatic plants 20 of the foreground grow horizontally, while the LEDs 12 with orange-red light are positioned at the rear side for controlling the aquatic plants 21 to grow upward. Thus, a user can control the growing space and speed of the aquatic plants according to needs in plant landscaping. Evidently, the LEDs of this invention are much more efficient than the conventional lamps.

In addition, the wave bands of 300 nm-400 nm, which are approximate to ultraviolet rays, are helpless to the photosynthesis of aquatic plants, but, on the contrary, harmful to the aquatic plants because the aquatic plants, worrying about being irradiated and injured by ultraviolet rays, will produce a pigment called as anthocyanosides in the leaf tissue, which is mainly red and able to absorb and filter ultraviolet rays to protect themselves from being injured. The reason why red aquatic plants 22 become red is that anthocyanosides is produced. Therefore, wishing to cultivate red aquatic plants 22 in an aquarium 3, a user can additionally provide LED light source 1 of LEDs 13 with such wave bands to enable the red aquatic plants 22 present resplendent red color.

The LED 10 has many excellent characteristics: The output efficiency of its effective light quantity is up to 100%, having high efficiency and greatly saving electricity, that is to say, under the same condition of lighting, the power consumption of an LED is only ½˜ 1/10 of a conventional lamp. Furthermore, the service life of an LED 10 is up to 50,000 hours, that is, under a normally using condition, say, lighting for 8 hours a day, the LED 10 can last for 17 years, able to greatly lower cost in repairing and replacing. Moreover, unlike conventional lamps, the LED does not contain any heavy metal, such as lead, mercury and the like, impossible to release heavy metal to pollute the environment.

As can be understood from the above description, this invention has the following advantages.

1. This invention selects specific wavelengths that are beneficial to the growth of plants and can offer best light for human naked eyes, and the LEDs composed of multiple wavelengths can greatly reduce light loss during light output and can be extensively employed for helping terrestrial plants and flowers or the aquatic plants in an aquarium to grow as well as for lighting.

2. The LEDs with different wavelengths and colors can be combined into different groups and arranged in sequence, flexible and efficient in use.

3. Compared with the conventional lamps, the LED light source used in the present invention is much better in saving electricity and in using efficiency under the same condition of lighting, and its service life can last for nearly 17 years under a normally using condition, greatly lowering cost in replacement.

4. The LED used as a light source does not contain any heavy metal, such as lead, mercury and the like, impossible to pollute the environment and contributing to environmental protection.

While the preferred embodiments of the invention have been described above, it will be recognized and understood that various modifications may be made therein and the appended claims are intended to cover all such modifications that may fall within the spirit and scope of the invention.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A multifunction plant cultivation LED able to control the growing speed of plants, said LED having the composition material and component proportion properly selected to let said LED emit light with different wavelengths and colors, said LED with different wavelengths combined to make up an LED light source with multiple wavelengths, said LED light source able to produce light quantity with specific wavelengths for irradiating plants for controlling the growth of the plants.

2. The multifunction plant cultivation LED able to control the growing speed of plants as claimed in claim 1, wherein said specific wavelength is within 400 nm-490 nm.

3. The multifunction plant cultivation LED able to control the growing speed of plants as claimed in claim 1, wherein said specific wavelength is within 550 nm-555 nm.

4. The multifunction plant cultivation LED able to control the growing speed of plants as claimed in claim 1, wherein said specific wavelength is within 600 nm-700 nm.

5. The multifunction plant cultivation LED able to control the growing speed of plant as claimed in claim 1, wherein said specific wavelength is within 300 nm-400 nm.

6. The multifunction plant cultivation LED able to control the growing speed of plants as claimed in claim 1, wherein said LED can be combined into an LED light source through different sequences and ways in accordance with a user's needs.

7. The multifunction plant cultivation LED able control the growing speed of plants as claimed in claim 1, wherein said multifunction plant cultivation LED is used for irradiating terrestrial plants.

8. The multifunction plant cultivation LED able to control the growing speed of plants as claimed in claim 1, wherein said multifunction plant cultivation LED is used for irradiating light on the aquatic plants of an aquarium.

9. The multifunction plant cultivation LED able to control the growing speed of plants as claimed in claim 8, wherein said multifunction plant cultivation LED is positioned at a proper location higher than the water level of said aquarium.

10. The multifunction plant cultivation LED able to control the growing speed of plants as claimed in claim 8, wherein said multifunction plant cultivation LED is positioned at a proper location in the water of said aquarium.
